(19) United States
(12) Patent Application Publication
(10) Pub. No.: US 2022/0238994 A1
(43) Pub. Date: Jul. 28, 2022

(54) APPARATUS FOR REDUCING WIND RESISTANCE OF ANTENNA

(71) Applicants: ROSENBERGER TECHNOLOGIES CO., LTD., Suzhou (CN); Rosenberger Technologies LLC, Budd Lake, NJ (US)

(72) Inventors: Junhao SHI, Suzhou (CN); Dongfeng DING, Suzhou (CN)

(21) Appl. No.: 17/719,135

(22) Filed: Apr. 12, 2022

Related U.S. Application Data
(63) Continuation of application No. PCT/CN2020/103846, filed on Jul. 23, 2020.

(51) Int. Cl. H01Q 1/42

(52) U.S. Cl. CPC H01Q 1/42

(57) ABSTRACT

An apparatus for reducing the wind resistance of an antenna is provided. The apparatus includes a radome, an upper end cap and a lower end cap disposed on the upper and lower ends of the radome. The radome includes a windward surface, and at least one of the upper end cap or the lower end cap includes a bottom edge and a front contour surface. The front contour surface is formed by extending and bending from a portion of the bottom edge close to the windward surface in a longitudinal direction toward the center of the upper end cap or the lower end cap.

### CROSS-REFERENCE TO RELATED APPLICATION

This application is a continuation application of PCT application PCT/CN2020/103846, filed on Jul. 23, 2020, the entire content of which is incorporated herein by reference.

### FIELD OF THE DISCLOSURE

The present disclosure relates to the field of antenna system, in particular to an apparatus for reducing the wind resistance of an antenna.

### BACKGROUND

At present, the mainstream station building model for base station antennas uses a steel structure single-tube communication tower. This tower type has the advantages of small construction radius, less project area, and fast construction progress. However, there are also shortcomings of low stiffness of the tower body and excessive horizontal displacement of the tower top. The base station antenna is usually installed at an altitude of tens of meters, and the wind speed in the high altitude is higher, so higher requirements for the reliability of the antenna are put forward.

A radome is a structure that protects the antenna system from the external environment. It has good electromagnetic wave penetration characteristics in electrical performance, and can withstand external harsh environments in mechanical performance. In addition to providing reliable mechanical protection for the base station antenna, the cross-sectional design of a radome also affects the electrical performance.

At present, most radomes have a rectangular cross-sectional shape. This cross-sectional shape is a bluff body shape, which will significantly increase the wind resistance of the base station antenna. In severe weather conditions, such as strong winds, great wind resistance may cause the antenna to induce certain safety hazards.

Currently, the wind resistance reduction method of a radome mainly focuses on how to change the cross-sectional shape of the radome to make the shape of the radome more in line with the hydrodynamic characteristics, and this implementation only considers the perspective of changing the antenna cross-section, and does not consider the influence of the longitudinal direction of the base station antenna.

### SUMMARY

The purpose of the present disclosure is to overcome the defects in the prior art and provide an apparatus for reducing the wind resistance of an antenna.

In order to achieve the above objective, the present disclosure provides the following technical solution: an apparatus for reducing the wind resistance of an antenna, comprising a radome, an upper end cap and a lower end cap disposed at the upper and lower ends of the radome, respectively, the radome including a windward surface. At least one of the upper end cap or the lower end cap includes a bottom edge and a front contour surface, the front contour surface is formed by extending and bending from a portion of the bottom edge close to the windward surface in a longitudinal direction toward the center of the upper end cap or the lower end cap.

In some embodiments, at least one of the upper end cap or the lower end cap further comprises a first transitional contour surface extending from one end of the front contour surface to one side of the radome and in a direction away from the windward surface.

In some embodiments, at least one of the upper end cap or the lower end cap further comprises a bottom surface formed by the bottom edge and a rear contour surface, and two first transitional contour surfaces extending from two ends of the front contour surface to two sides of the radome. The rear contour surface, the front contour surface and the first transitional contour surfaces at the two sides are connected together and formed on the bottom surface.

In some embodiments, at least one of the upper end cap or the lower end cap further comprises a top surface, a side contour surface and a rear contour surface, and the longitudinal projection of an edge of the top surface is located inside the bottom edge of the end cap, the rear contour surface is opposite to the front contour surface, the side contour surface connects the first transitional contour surface and the rear contour surface. The front contour surface, the first transitional contour surface, the side contour surface and the rear contour surface are formed by extending from the corresponding edge of the bottom surface to the corresponding edge of the top surface.

In some embodiments, at least one of the upper end cap or the lower end cap further comprises a second transitional contour surface located between the side contour surface and the rear contour surface. At least one of the upper end cap or the lower end cap is symmetrical along a transverse and/or longitudinal center axis.

In some embodiments, the radome further comprises a mounting surface opposite to the windward surface and two side surfaces connecting the windward surface and the mounting surface, the width of the mounting surface is greater than the width of the windward surface, and the two side surfaces extend obliquely to both sides of the radome, and the cross section of the entire radome is substantially trapezoidal.

In some embodiments, the apparatus further comprises a tail spoiler, and the tail spoiler is formed by extending rearward from a connection site between the two side surfaces and the mounting surface of the radome.

In some embodiments, the radome further comprises two connecting surfaces connecting the mounting surface and the side surface, and at least one of the rear contour surface and the two connecting surfaces includes a non-smooth surface.

In some embodiments, the non-smooth surface includes a plurality of vortex generators arranged on the non-smooth surface at intervals or a plurality of evenly arranged concave and/or convex points.

In some embodiments, the vortex generators are protrusions arranged at intervals on the non-smooth surface.

The beneficial effects of the present disclosure are listed as follows:

1. In the present disclosure, some contour features are provided on the radome and its end caps, so that the fluid separation point of the radome is delayed to the tail of the radome, and the wind resistance of the antenna is reduced through the design of the shape, which not only improves the reliability of the antenna, and can reduce the installation and fixing cost of base station antennas.

2. In addition, the wind resistance of the antenna can be further reduced by combining a trailing vortex resistance reduction structure and a pneumatic accessory resistance reduction structure.

3. The present disclosure can significantly suppress the fluid separation in the longitudinal direction of the radome without changing the cross-sectional shape of the radome, so that it can be compatible with various cross-section shapes of radome, and thus it has a strong versatility, does not increase the size of the antenna, and does not affect the internal layout of the antenna and has good space utilization. In addition, it has the advantages of convenient installation, easy for mass production, and good market application prospects.

### BRIEF DESCRIPTION OF THE DRAWINGS

FIG. 1 is a perspective view of the radome of the present disclosure with only a front contour surface provided on the end cap;

FIG. 2 is an exploded perspective view of radome of FIG. 1;

FIG. 3 is a perspective view of a radome of another embodiment of the present disclosure;

FIG. 4 is an exploded perspective view of the radome of FIG. 3;

FIG. 5 is a perspective view of the radome with a flat end cap of the present disclosure;

FIG. 6 is an exploded perspective view of the radome of FIG. 5;

FIG. 7 is a perspective view of the radome of FIG. 3 with an additional vortex generator;

FIG. 8 is a perspective top view of the radome of FIG. 3 with an additional rear spoiler;

FIG. 9 is a schematic diagram of results obtained by computational fluid dynamics simulation of a conventional radome and an exemplary radome of the present disclosure;

### REFERENCE NUMERALS

10 radome, 11 windward surface, 12 mounting surface, 13 side surface, 14 connecting surface, 20 upper end cap, 30 lower end cap, 41/41′ front contour surface, 42/42′ first transitional contour surface, 44/44′ rear contour surface, 50 top surface, 62 second transitional contour surface, 70 side contour surface, 80 vortex generator/protrusion, and 90 tail spoiler plate.

### DETAILED DESCRIPTION

The technical solutions of the embodiments of the present disclosure will be clearly and completely described below in conjunction with the accompanying drawings of the present disclosure.

The present disclosure discloses an apparatus for reducing the wind resistance of the antenna. Through one or more optimized design from the low-resistance design of the radome, increasing the resistance reduction design of pneumatic accessories, and wake vortex control resistance reduction design, the wind resistance of the base station antenna is significantly reduced, and thereby improving the reliability of the antenna and reducing the installation and fixing cost of the base station antenna.

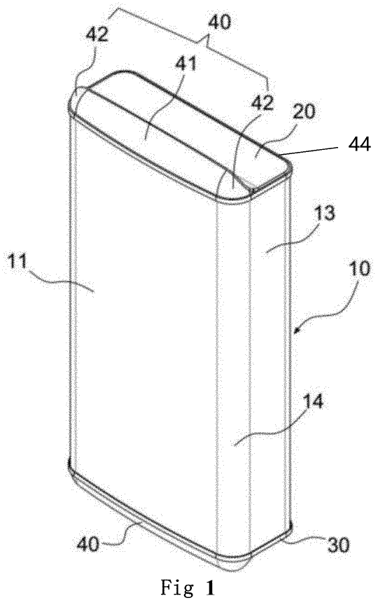

In conjunction with FIGS. 1 to 4, an apparatus for reducing the wind resistance of an antenna disclosed in the present disclosure includes a radome 10, an upper end cap 20, and a lower end cap 30. The upper end cap 20 and the lower end cap 30 are mounted on the upper end and the lower end of radome 10, respectively.

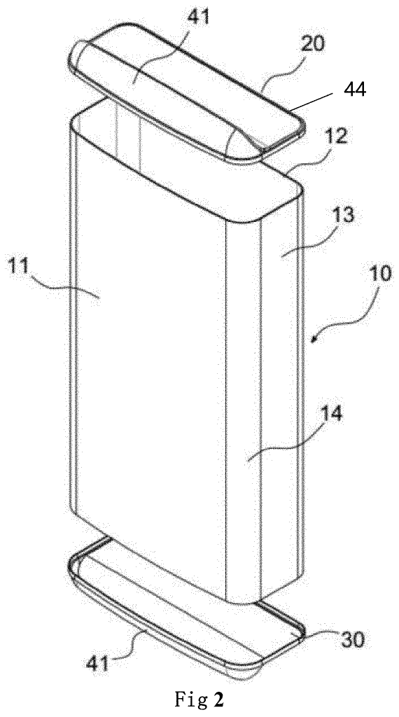

The radome 10 is formed by a pultrusion process at one time, and an accommodation space for installing an antenna system is formed in the radome to protect the antenna system from the external environment. As shown in FIG. 2, the radome 10 includes specifically a windward surface 11, a mounting surface 12, two side surfaces 13 and four connecting surfaces 14. The windward surface 11 is the radiating surface of the radome 10, and the mounting surface 12 is opposite to the windward surface 11 and used to install the radome 10 on the antenna pole (not shown in the figure). The two side surfaces 13 are located on both sides of the radome 10 respectively and connect the windward surface 11 and the mounting surface 12. The windward surface 11 and each of the two side surfaces 13 are connected at the corner by a connecting surface 14, respectively, and the mounting surface 12 and each of the two side surfaces 13 are connected by a connecting surface 14 at the connecting corner, respectively.

Specifically, the connecting surface 14 extends from the top to the bottom of the radome 10, and the connecting surface 14 is an arc surface protruding to the outside of the radome 10. The design of the arc surface can make the fluid transition smooth at the connecting corners of the radome 10 and prevent the wind from separating at the connecting corners of the radome 10. In some embodiments, the windward surface 11 of the radome can also be designed as an arc surface protruding to the outside of the radome 10. The design of the arc surface can make the wind quickly stick to the radome 10 when it first hits the radome 10. In other embodiments, the cross-sections of the connecting surface 14 and the windward surface 11 may also be other shapes (such as chamfers, tapered angles, or special-shaped angles) that can reduce wind resistance, which are not limited in the present disclosure.

The upper end cap 20 and the lower end cap 30 are processed by injection molding. As used herein, an end cap refers to the upper end cap 20 and/or the lower end cap 30. In conjunction with FIG. 1 and FIG. 2, an end cap is provided with a front contour surface 41 at least on the side close to the windward surface 11, and the front contour surface 41 is formed to extend from an edge of the end cap close to the windward surface in a longitudinal direction and bend toward the center of the end cap. As shown in FIG. 1, the end cap includes specifically a front contour surface 41, first transitional contour surfaces 42 located on both sides of the front contour surface 41 and a rear contour surface 44_{[QW1][ABQ2][QW3][ABQ4]}, wherein the front contour surface 41 is formed to extend from the edge of the end cap close to the windward surface 11 in a longitudinal direction and bend toward the center of the end cap. Two first transitional contour surfaces 42 are formed by extending the two ends of the front contour surface 41 in a direction toward both sides and away from the windward surface 11. In implementation, the longitudinal section of the front contour surface 41 may be any one of rounded corners, chamfered corners, tapered angles, and special-shaped corners. In this embodiment, the front contour surface 40 is an arc surface. The bottom surface is located at the bottom of the end cap, and covers the top or bottom of the radome 10. The front contour surface 41, the two first transitional contour surfaces 42 and the rear contour surface 44 are all formed on the bottom surface. The rear contour surface 44, the front contour surface 41 and the two first transitional contour surfaces 42 on both sides are connected together and formed on the bottom surface.

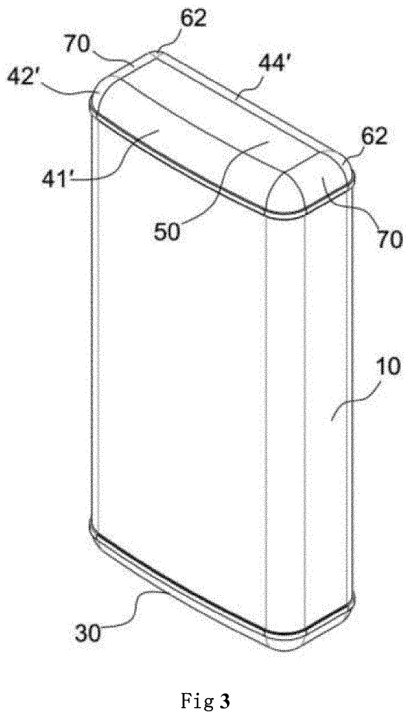

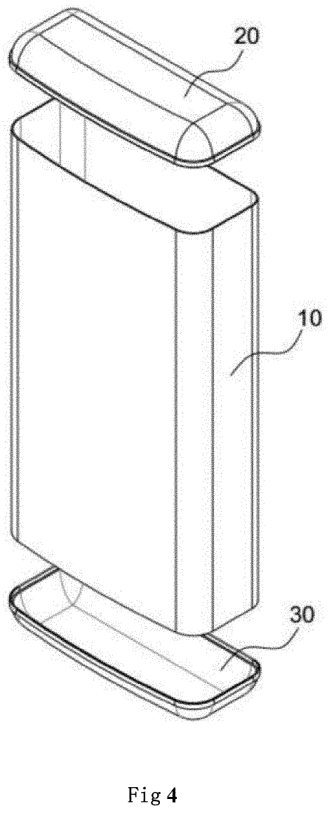

In other alternative embodiments, as shown in FIGS. 3 and 4, both the upper end cap 20 and the lower end cap 30 include a top surface 50, a front contour surface 41′, a first transitional contour surface 42′, _{[QW5][ABQ6][QW7][ABQ8]} a side contour surface 70, a rear contour surface 44′ and a second transitional contour surface 62. In some embodiments, the upper end cap 20 and/or the lower end cap 30 may include two or more first transitional contour surfaces 42′, two or more side contour surfaces 70, and/or two or more second transitional contour surfaces 62. As used herein, the end cap refers to the upper end cap 20 and/or the lower end cap 30. The top surface 50 is located above the bottom edge of the end cap and the longitudinal projection of the edge of the top surface 50 is located inside the bottom edge of the end cap. The structures of the front contour surface 41′ and the first transitional contour surfaces 42′ are the same as the structures of the front contour surface 41 and the first transitional contour surfaces 42 in FIG. 1, thus it will not be described repeatedly here. Each side contour surface 70 is formed to extend from an edge of the end cap close to a side surface 13 in a longitudinal direction and toward center of the end cap, and each side contour surface 70 connects one of the first transitional contour surfaces 42′, one of the second transitional contour surfaces 62 and the top surface 50. The rear contour surface 44′ is opposite to the front contour surface 40, and the rear contour surface 44′ is formed to extend from an edge of the end cap close to the mounting surface 12 in a longitudinal direction and bend toward the center of the end cap, and extends to connect the corresponding edge of the top surface 50. Each second transitional contour surface 62 is formed to extend from an edge of the end cap close to the connecting surface 14 (specifically the connecting surface between the mounting surface 12 and the side surface 13) in a longitudinal direction and bend toward the center of the end cap, and the second transitional contour surface 62 connects the rear contour surface 44′ and the side contour surface 70.

In one example, the longitudinal section of the front contour surface 41′, the rear contour surface 44′, and the side contour surface 70 can be any one of rounded corner, chamfered corner, tapered angle, and special-shaped corner. In this embodiment, the contour surface of the upper end cap 20 and the lower end cap 30 are both arc surfaces.

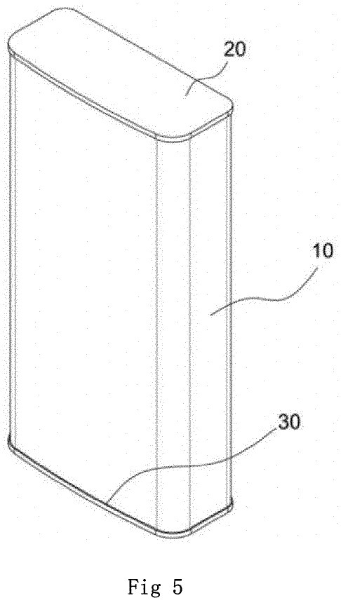

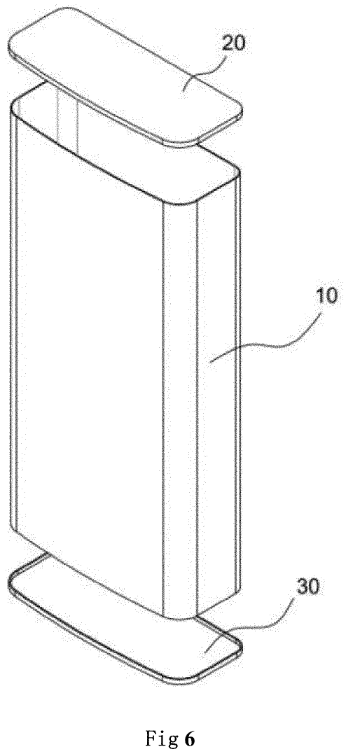

As shown in FIG. 5 and FIG. 6, in other alternative embodiments, the upper end cap 20 or the lower end cap 30 may also be planar structures.

In the present disclosure, some contour features are provided on the upper end cap 20 and the lower end cap 30, such as rounded corners, chamfered corners, tapered angles, special-shaped corners, etc., so that when the wind passes through the end cap, these contour features can make the wind flow smoothly without generating fluid separation points at these places. Compared with the conventional upper and lower end caps, the present disclosure can move the longitudinal fluid separation point of the radome 10 from the front end of the end cap to the rear portion of the end cap, thereby achieving the purpose of reducing the wind resistance of the radome. Taking a radome with the size of 500 mm×498 mm×196 mm as an example, the overall wind load of the antenna is 202N when the radiating surface of the radome is windward before the apparatus of the invention is installed, while the overall wind load of the antenna is 105N after the installation of radome of the invention, and thus the wind load has reduced by 48%.

In addition, in the low-resistance design of the radome 10, the radome 10 can also be designed overall as a trapezoid with a narrow front and a wide rear in a cross-section. Specifically, the width of mounting surface 12 is designed as greater than the width of the windward surface 11, so that the two side surfaces 13 extend obliquely to both sides, and the cross-section of the entire radome is substantially trapezoidal. This design can also reduce the air resistance on the radome to a certain extent, and the corresponding cross-sections of the upper end cap 20 and the lower end cap 30 on the radome 10 are also trapezoidal with a narrow front and a wide rear.

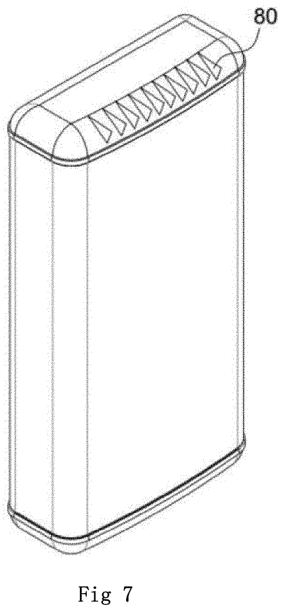

When the wind flows to the tail of the radome 10, separation of the fluid is easy to occur. Therefore, the tail control and resistance reduction design can be carried out at the tail of the radome, so that the wind can quickly leave the radome and avoid being caught behind the radome to increase the eddy current area, and thus increase resistance. If the tail of the apparatus of the present disclosure is designed as a non-smooth surface, the non-smooth surface can be realized by arranging a vortex generator 80 at the tail of the apparatus, where the tail can be arranged on at least one surface including a rear contour surfaces 44′ on the upper end cap, a rear contour surfaces 44′ on the lower end cap, connecting surfaces 14 connecting the mounting surface 12 and the two side surfaces 13. As shown in FIG. 7, a plurality of protrusions 80 arranged at intervals are provided on the rear contour surface 44′ of the upper end cap 20, and the plurality of protrusions 80 are laterally distributed and spaced apart on the rear contour surface 44′. In addition, it can also be implemented by arranging a plurality of uneven concave/convex structure at the tail of the apparatus, which can also reduce the wind resistance of the radome 10 to a certain extent.

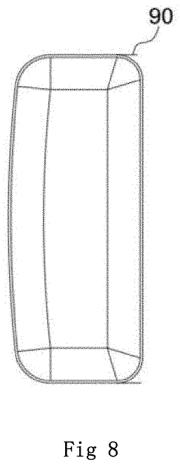

In addition, because there is a theoretical fluid separation point on the side surface of the radome 10, certain pneumatic accessories can be used to reduce resistance at this position. As shown in FIG. 8, the two side surfaces 13 of the radome 10 are connected to the mounting surface 12 to extend backward to form a tail spoiler 90, which is used to divert the wind flowing through a side surface of the radome to the rear of the radome (that is, a side close to the mounting surface 12).

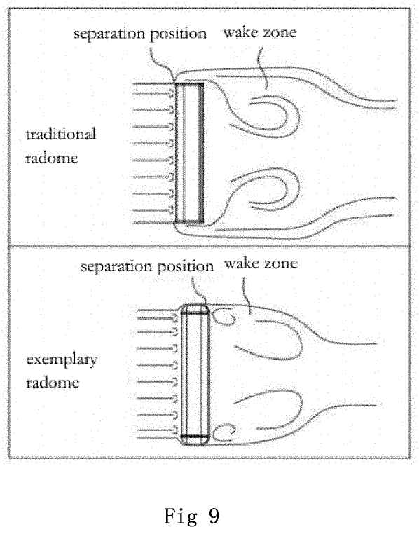

As shown in FIG. 9, it is a schematic view illustrating the results obtained by computational fluid dynamics simulation of the traditional radome and the example radome of the present disclosure. As shown in FIG. 9, it can be seen that the fluid separation point of the traditional radome occurs at the front portion of the radome, while the fluid separation point of the radome in the example of the present disclosure is delayed to the tail of the radome. The wake near the back of the radome is also shown in FIG. 9. Comparing the two wakes, it can be seen that the exemplary radome of the present disclosure weakens the separation phenomenon, and its wake is smaller than that of the original radome, so the negative pressure area it generates is also smaller. The wind pressure on the back of the radome (that is, the mounting surface 12) will be reduced, which can achieve the purpose of resistance reduction.

The technical content and technical features of the present disclosure have been disclosed above, but those skilled in the art may still make various substitutions and modifications based on the teachings and disclosures of the present disclosure without departing from the spirit of the present disclosure. Therefore, the scope of protection of the present disclosure should not be limited to the disclosure in the embodiments, but should include various substitutions and modifications that do not deviate from the present disclosure, and are covered by the claims of this patent application.

1. An apparatus for reducing the wind resistance of an antenna, comprising:
a radome comprising a windward surface,
an upper end cap disposed at an upper end of the radome, and
a lower end cap disposed at a lower end of the radome,
wherein: the upper end cap comprises a bottom edge and a front contour surface, the front contour surface being formed by extending and bending from a portion of the bottom edge close to the windward surface in a longitudinal direction toward a center of the upper end cap.

2. The apparatus according to claim 1, wherein the upper end cap further comprises a first _{[ABQ9][QW10][ABQ11]} transitional contour surface extending from one end of the front contour surface to one side of the radome and in a direction away from the windward surface.

3. The apparatus according to claim 2, wherein:
the upper end cap further comprises a bottom surface formed by the bottom edge and a rear contour surface;
the upper end cap comprises two first transitional contour surfaces extending from two ends of the front contour surface to two sides of the radome; and
the rear contour surface, the front contour surface and the first transitional contour surfaces at the two sides are connected together and formed on the bottom surface.

4. The apparatus according to claim 2, wherein:
the upper end cap further comprises a top surface, a side contour Surface_{[ABQ12][QW13][ABQ14]} and a rear contour surface;
a longitudinal projection of an edge of the top surface is located inside the bottom edge of the end cap;
the rear contour surface is opposite to the front contour surface;
the side contour surface connects the first transitional contour surface and the rear contour surface; and
the front contour surface, the first transitional contour surface, the side contour surface and the rear contour surface are formed by extending from the corresponding edge of the bottom surface to the corresponding edge of the top surface.

5. The apparatus according to claim 4, wherein:
the upper end cap further comprises a second transitional contour surface located between the side contour surface and the rear contour surface, and
the upper end cap is symmetrical along a transverse center axis and/or longitudinal center axis.

6. The apparatus according to claim 4, wherein:
the radome further comprises a mounting surface opposite to the windward surface and two side surfaces connecting the windward surface and the mounting surface,
a width of the mounting surface is greater than a width of the windward surface, and
the two side surfaces extend obliquely to both sides of the radome, and a cross section of the radome is substantially trapezoidal.

7. The apparatus according to claim 6, further comprising: a tail spoiler, wherein the tail spoiler is formed by extending rearward from a connection site between the two side surfaces and the mounting surface of the radome.

8. The apparatus according to claim 6, wherein:
the radome further comprises two connecting surfaces connecting the mounting surface and the side surface; and
at least one of the rear contour surface and the two connecting surfaces includes a non-smooth surface.

9. The apparatus according to claim 8, wherein the non-smooth surface includes a plurality of vortex generators arranged on the non-smooth surface at intervals or a plurality of evenly arranged concave and/or convex points.

10. The apparatus according to claim 9, wherein the vortex generators are protrusions arranged at intervals on the non-smooth surface.

11. An apparatus for reducing the wind resistance of an antenna, comprising:
a radome comprising a windward surface,
an upper end cap disposed at an upper end of the radome, and
a lower end cap disposed at a lower end of the radome,
wherein: the lower end cap comprises a bottom edge and a front contour surface, the front contour surface being formed by extending and bending from a portion of the bottom edge close to the windward surface in a longitudinal direction toward a center of the lower end cap.

12. The apparatus according to claim 11, wherein the lower end cap further comprises a first transitional contour surface extending from one end of the front contour surface to one side of the radome and in a direction away from the windward surface.

13. The apparatus according to claim 12, wherein:
the lower end cap further comprises a bottom surface formed by the bottom edge and a rear contour surface;
the lower end cap comprises two first transitional contour surfaces extending from two ends of the front contour surface to two sides of the radome; and
the rear contour surface, the front contour surface and the first transitional contour surfaces at the two sides are connected together and formed on the bottom surface.

14. The apparatus according to claim 12, wherein:
the lower end cap further comprises a top surface, a side contour surface and a rear contour surface;
a longitudinal projection of an edge of the top surface is located inside the bottom edge of the end cap;
the rear contour surface is opposite to the front contour surface;
the side contour surface connects the first transitional contour surface and the rear contour surface; and
the front contour surface, the first transitional contour surface, the side contour surface and the rear contour surface are formed by extending from the corresponding edge of the bottom surface to the corresponding edge of the top surface.

15. The apparatus according to claim 14, wherein:
the lower end cap further comprises a second transitional contour surface located between the side contour surface and the rear contour surface, and
the lower end cap is symmetrical along a transverse center axis and/or longitudinal center axis.

16. The apparatus according to claim 14, wherein:
the radome further comprises a mounting surface opposite to the windward surface and two side surfaces connecting the windward surface and the mounting surface,
a width of the mounting surface is greater than a width of the windward surface, and
the two side surfaces extend obliquely to both sides of the radome, and a cross section of the radome is substantially trapezoidal.

17. The apparatus according to claim 16, further comprising: a tail spoiler, wherein the tail spoiler is formed by extending rearward from a connection site between the two side surfaces and the mounting surface of the radome.

18. The apparatus according to claim 16, wherein:
the radome further comprises two connecting surfaces connecting the mounting surface and the side surface; and
at least one of the rear contour surface and the two connecting surfaces includes a non-smooth surface.

19. The apparatus according to claim 18, wherein the non-smooth surface includes a plurality of vortex generators arranged on the non-smooth surface at intervals or a plurality of evenly arranged concave and/or convex points.

20. The apparatus according to claim 19, wherein the vortex generators are protrusions arranged at intervals on the non-smooth surface.
